(19) United States
(12) Patent Application Publication
(10) Pub. No.: US 2008/0123208 A1
(43) Pub. Date: May 29, 2008

(54) METHOD FOR OPTIMIZING PARAMETER OF INFORMATION STORAGE APPARATUS

(75) Inventor: YEN-HSU CHEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/617,085

(22) Filed: Dec. 28, 2006

(30) Foreign Application Priority Data
Nov. 27, 2006 (CN) 200610201145.3

(51) Int. Cl. G11B 5/02

(52) U.S. Cl. 360/25

(57) ABSTRACT

A method is used for optimizing a parameter of an processing unit. The method is for providing an initial input Fᵢ₌₀ to be a value of the parameter, and detecting a corresponding initial output O(Fᵢ₌₀), determining step value ΔF, providing a first input F₀−ΔF and a second input F₀+ΔF, detecting a first output O(F₀−ΔF) and a second output O(F₀+ΔF), determining whether the first output O(F₀−ΔF) is greater than the second output O(F₀+ΔF), determining a first seeking direction, providing other inputs Fᵢ, Fᵢ₊₁, Fᵢ₊₂, . . . Fᵢ₊ₙ₋₁, and then detecting corresponding other outputs O(Fᵢ), O(Fᵢ₊₁), O(Fᵢ₊₂), . . . O(Fᵢ₊ₙ₋₁), wherein n is a natural number, determining a stop point Fᵢ, stopping seeking along the first seeking direction at the stop point, identifying an extremum output, and identifying an input to be the optimized value of the parameter. An information storage apparatus for optimizing a parameter is also disclosed.

### BACKGROUND OF THE INVENTION

1. Field of the Invention

This invention relates to information storage apparatuses and, more particularly, to a method for optimizing parameters of an information storage apparatus.

2. Description of Related Art

Information storage apparatuses, such as video compact disc (VCD) players and digital versatile disc (DVD) players, are widely used for reproducing information from and/or recording information onto discs. A general information storage apparatus includes a plurality of processing units for processing a plurality of tasks. For example, a light source executes a projection of a light beam, and a detector executes a detection of a reflected light beam. Usually, each processing unit is assigned at least one adjustable parameter that is used for adjusting a performance of the information storage apparatus.

Therefore, it is important to determine values of the parameters of each processing unit. A conventional determining method includes following steps: providing various value groups to the parameters and detecting various output signals of an processing unit corresponding to the various value groups; comparing the output signals to select at least one output signal therefrom which reflect a best performance of an information storage apparatus; identifying the value groups corresponding to the selected output signals to be optimal values of the parameters. However, this determining method is time-consuming and in a low efficiency.

Therefore, an improvement of a method for optimizing the parameter of an information storage apparatus is desired.

### SUMMARY OF THE INVENTION

A method is used for optimizing a parameter of an processing unit. The method is for providing an initial input Fᵢ₌₀ to be a value of the parameter, and detecting a corresponding initial output O(Fᵢ₌₀), determining step value ΔF, providing a first input F₀−ΔF and a second input F₀+ΔF, detecting a first output O(F₀−ΔF) and a second output O(F₀+ΔF), determining whether the first output O(F₀−ΔF) is greater than the second output O(F₀+ΔF), determining a first seeking direction, providing other inputs Fᵢ, Fᵢ₊₁, Fᵢ₊₂, . . . Fᵢ₊ₙ₋₁, and then detecting corresponding other outputs O(Fᵢ), O(Fᵢ₊₁), O(Fᵢ₊₂), . . . O(Fᵢ₊ₙ₋₁), wherein n is a natural number, determining a stop point Fᵢ, stopping seeking along the first seeking direction at the stop point, identifying an extremum output, and identifying an input to be the optimized value of the parameter. An information storage apparatus for optimizing a parameter is also disclosed.

Other advantages and novel features will become more apparent from the following detailed description of preferred embodiments when taken in conjunction with the accompanying drawings, in which:

### BRIEF DESCRIPTION OF THE DRAWINGS

Many aspects of the method of optimizing an parameter and the information storage apparatus using the method can be better understood with reference to the following drawings. The components in the drawings are not necessarily to scale, the emphasis instead being placed upon clearly illustrating the principles of the present disc drive. Moreover, in the drawings, like reference numerals designate corresponding parts throughout the several views.

FIG. 1 is a block diagram of an processing system;

FIG. 2 is a block diagram of a typical information storage apparatus;

FIG. 3 is schematic diagram of an exemplary graph illustrating relationships between inputs and outputs;

FIG. 4 is a flow chart illustrating an method for optimizing an parameter in accordance with an first exemplary embodiment; and

FIG. 5 is schematic diagram of exemplary graph illustrating three minimum O(Fᵢ)s.

### DETAILED DESCRIPTION OF THE INVENTION

Reference will now be made to the drawings to describe the preferred embodiments of the present method of determining an optimal parameter and the present information storage apparatus, in detail.

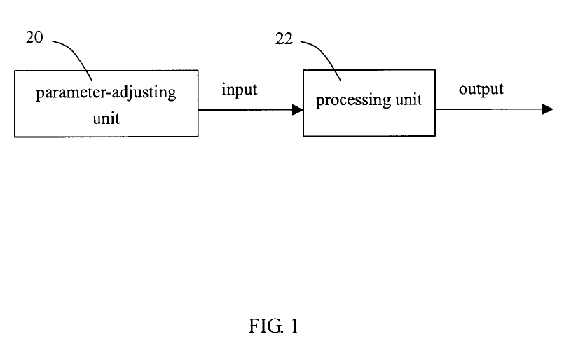

Referring to FIG. 1, a schematic block diagram of a processing system is illustrated. The processing system includes an processing unit 22 assigned with at least one parameter, and a parameter-adjusting unit 20 for adjusting values of the at least one parameter of the processing unit 22.

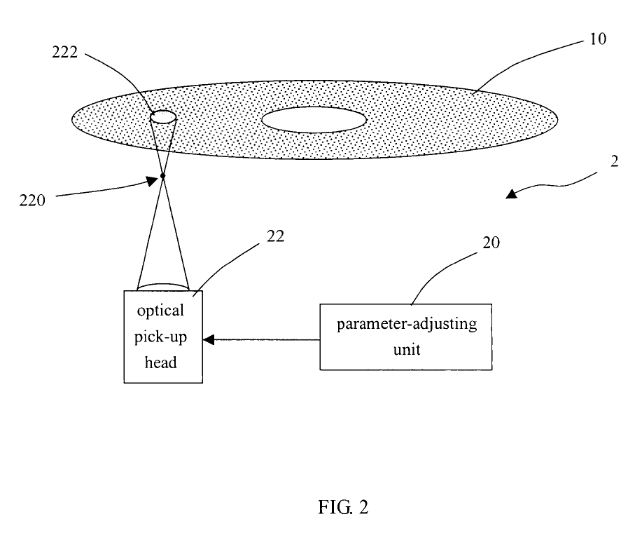

Referring to FIG. 2, an information storage apparatus 2 acts as an embodiment of the processing system, and an optical pick-up head 22 acts as an embodiment of the processing unit in the information storage apparatus 2. The optical pick-up head 22 projects a light beam to a disk 10 to form a spot 222 on the disk 10 and receives a reflected light beam from the disk 10. A plurality of adjustable parameters is preconfigured in the optical pick-up head 22. The information storage apparatus 2 further includes a parameter-adjusting unit 20 for adjusting values of the parameters of the optical pick-up head 22, thus improving a performance of the information storage apparatus 2. For example, an Fbias (focus equalizer bias voltage) parameter is assigned to the optical pick-up head 22, a value of which represents a deviation of a focus 220 of the light beam away from the spot 222 in a perpendicular direction relative to the disk 10. The deviation of the focus 220 affects qualities of reproduced or recorded information.

Therefore, it is important to identify optimal values of the parameters of each processing unit 22. The processing unit 22 has optimal outputs according to the optimal values of the parameters. A method to identify at least one optimal value of a parameter includes the following steps: providing a series of inputs Fᵢ; detecting a series of outputs O(Fᵢ) of a processing unit corresponding to the inputs Fᵢ; identifying an extremum from the series of the outputs O(Fᵢ); identifying at least one input Fᵢ which corresponds to the extremum of the series of the outputs O(Fᵢ) to be the optimal value of the corresponding parameter. Wherein “i” is an index identifier.

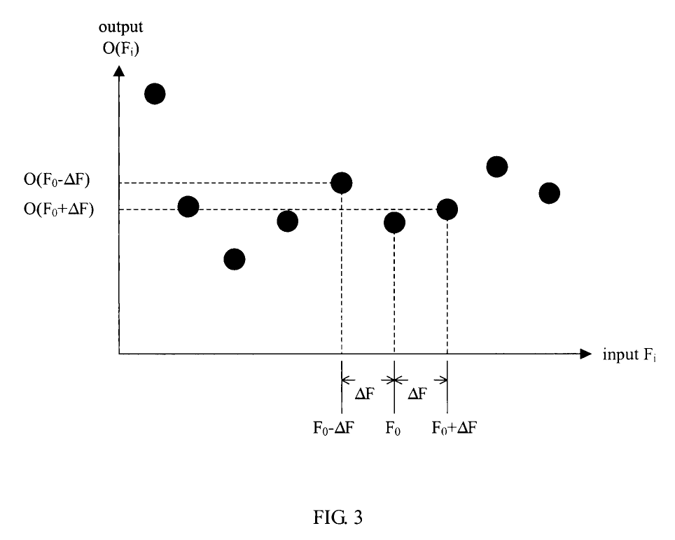

Referring to FIG. 3, an exemplary graph illustrating relationships between the inputs Fᵢ and the outputs O(Fᵢ). An initial input F₀ is predetermined on the X-axis. A first input F₀−ΔF and a second input F₀+ΔF are located on two sides of the F₀. A first output O(F₀−ΔF) and a second output O(F₀+ΔF) are determined. A seeking direction is defined by a comparison result between the two outputs O(F₀−ΔF) and O(F₀+ΔF). For example, if a minimum deviation, i.e. a minimum value of the output of the processing unit, is wanted, and the comparison result shows the second output O(F₀+ΔF) is less than the first output O(F₀−ΔF), the seeking direction is a forward direction on the X-axis. On the other hand, if the minimum deviation is wanted and the comparison result shows that the second output O(F₀+ΔF) is greater than the first output O(F₀−ΔF), the seeking direction is a backward direction on the X-axis. A series of other inputs Fᵢs, such as F₀+2ΔF and F₀+3ΔF, are provided along the seek direction, so as to detect a series of corresponding outputs O(Fᵢ)s. Such a seeking operation continues until the input Fᵢ satisfies a relationship of O(Fᵢ)<O(Fᵢ₊₁)<O(Fᵢ₊₂)<O(Fᵢ₊₃), an optimal output with a wanted extremum is then obtained by comparing the outputs O(Fᵢ)s. Thereby, at least one optimal input that corresponds to the output with the extremum is identified as the optimal values of the parameter.

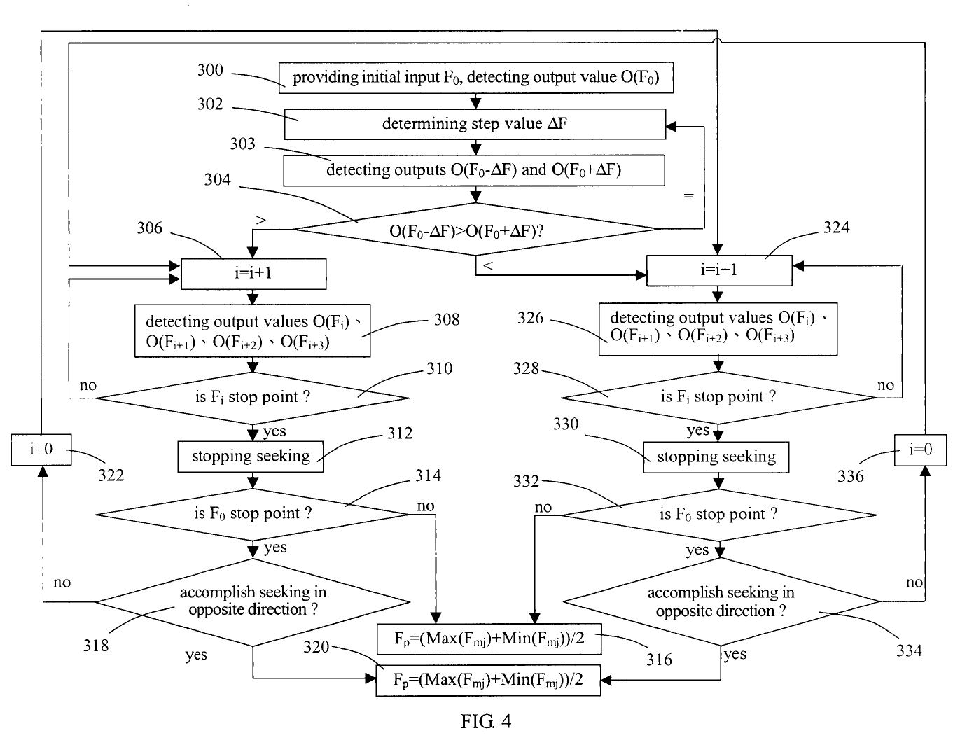

Referring to FIG. 4, a flow chart showing a seeking procedure of a method for identifying at least one optimal input Fₚ corresponding to an output O(Fₚ) having a minimum value for the processing unit 22 in accordance with a first exemplary embodiment is illustrated. The seeking procedure can be performed by a program stored in the parameter-adjusting unit 20.

Step 300, an initial input F₀ is provided to the processing unit 22 and an output O(F₀) is computed correspondingly.

Step 302, the value of the step ΔF is determined.

Step 303, two other inputs F₀−ΔF and F₀+ΔF are provided to the processing unit 22, and two other output O(F₀−ΔF) and O(F₀+ΔF) are detected.

Sep 304, a conclusion whether the O(F₀−ΔF) is greater than O(F₀+ΔF) is made.

If the conclusion indicates that the first output O(F₀−ΔF) is equal to the second output O(F₀+ΔF), the procedure returns to step 302 to reset the step value ΔF.

Step 306, if the conclusion shows that the first output O(F₀−ΔF) is greater than the second output O(F₀+ΔF), a first seeking direction (e.g. an increasing direction of F₀) is defined as a seek direction, and i is increased by 1.

After that, in step 308, a series of successive inputs Fᵢ, Fᵢ₊₁, Fᵢ₊₂, Fᵢ₊₃ are fed to the processing unit 22, and corresponding outputs O(Fᵢ), O(Fᵢ₊₁), O(Fᵢ₊₂), and O(Fᵢ₊₃) are detected.

Subsequently, step 310, a determination whether Fᵢ is a stop point is made by comparing values of the outputs O(Fᵢ), O(Fᵢ₊₁), O(Fᵢ₊₂), and O(Fᵢ₊₃). That is, if Fᵢ satisfies the relationship of O(Fᵢ)<O(Fᵢ₊₁)<O(Fᵢ₊₂)<O(Fᵢ₊₃), the Fᵢ is identified as the stop point.

If the Fᵢ concluded in step 310 is not the stop point, the procedure goes back to step 306 where i is increased by 1. If the Fᵢ concluded in step 310 is the stop point, the procedure proceeds to step 312 where the seeking procedure is stopped.

After the seeking procedure, step 314, a determination whether F₀ is the stop point is made. If F₀ satisfies relationship of O(F₀)<O(f₁)<O(f₂)<O(f₃), F₀ is identified as the stop point.

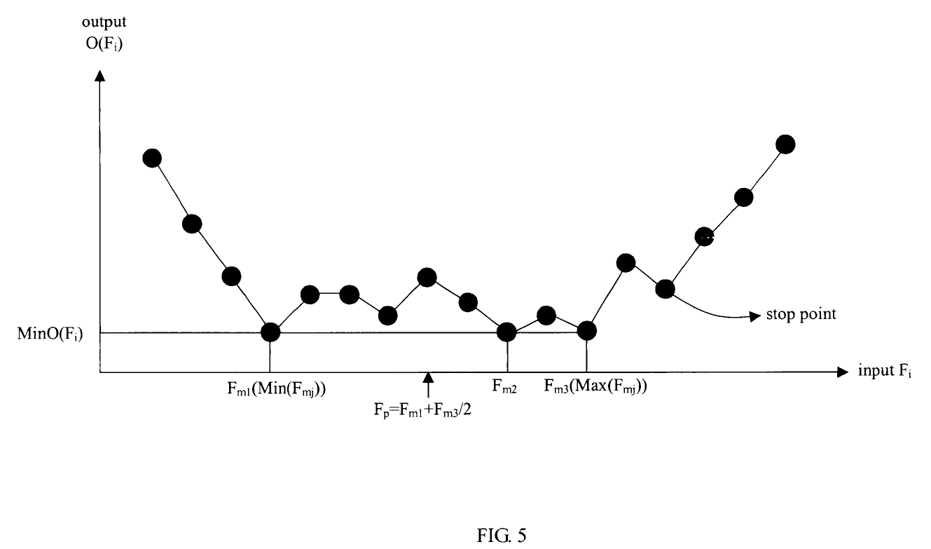

Step 316, if F₀ concluded in step 314 is not the stop point, the optimal input Fₚ is determined. At least one minimum O(Fᵢ) is determined by comparing the O(Fᵢ)s detected in step 308. The minimum O(Fᵢ)s which have a same minimum value are identified as O(Fᵢⱼ), wherein j is an integer representing the number of the minimum O(Fᵢ). The inputs corresponding to the O(Fᵢⱼ) are then identified as Fᵢⱼ. Then, an average of Max(Fᵢⱼ) and Min(Fᵢⱼ) is identified to be the optimal input Fₚ. If only one minimum O(Fᵢ) is obtained, j equals to 1, and Fₚ satisfies an equation of Fₚ=(Max(Fᵢⱼ)+Min(Fᵢⱼ))/2=(Fᵢ₁+Fᵢ₁)/2=Fᵢ₁. If two or more minimum O(Fᵢ)s are obtained, there are a maximum Fᵢⱼ (Max(Fᵢⱼ)) and a minimum Fᵢⱼ (Min(Fᵢⱼ)) corresponding to the minimum O(Fᵢ)s, and the Fₚ satisfies an equation of Fₚ=(Max(Fᵢⱼ)+Min(Fᵢⱼ))/2. For instance, referring to FIG. 5, three minimum O(Fᵢ)s are obtained. Fₘ₁, Fₘ₂, and Fₘ₃ are corresponding to the minimum O(Fᵢ)s, wherein Fₘ₁<Fₘ₂<Fₘ₃. Thus, the Fₚ satisfies an equation of Fₚ=(Fₘ₁+Fₘ₃)/2.

Step 318, if F₀ concluded in step 314 is the stop point, a determination whether seeking procedure towards a second seeking direction, opposite to the first seeking direction, from the initial input F₀ have been done is made.

Step 320, if the determination in step 318 shows that the seeking procedure towards the second seeking direction have been done, the optimal input Fₚ is determined to be F₀.

Step 322, if the determination in step 318 shows that the seeking procedure towards the second seeking direction have not been done, i is reset to a value of zero, and then the procedure jumps to step 324 where i is decreased by 1.

Step 324, if the conclusion shows that the first output O(F₀−ΔF) is less than the second output O(F₀+ΔF), the seek direction along the second seeking direction is started and i is increased by 1.

Step 326, a similar seeking operation is executed as step 308 along the second seeking direction.

Step 328, a determination is made by a same operation which is executed as step 310.

If the Fᵢ concluded in step 328 is not the stop point, the procedure goes back to step 324 where i is increased by 1. If the Fᵢ concluded in step 328 is the stop point, the procedure proceeds to step 330 where the seeking procedure is stopped.

After the seeking procedure, step 332, a determination whether F₀ is the stop point is made. In step 332, if F₀ satisfies relationship of O(F₀)<O(f₁)<O(f₂)<O(f₃), the F₀ is identified as the stop point.

If the F₀ concluded in step 332 is not the stop point, the optimal input Fₚ is determined (step 316). At least one minimum O(Fᵢ) is determined by comparing the O(Fᵢ)s recorded in step 326. The at least one minimum O(Fᵢ) is identified as O(Fᵢⱼ)s, wherein j is an integer representing the number of the minimum O(Fᵢ) and is not less than 1. Then, corresponding to the at least one O(Fᵢⱼ), at least one input Fᵢⱼ are determined, and the Fₚ satisfies an equation of Fₚ=(Max(Fᵢⱼ)+Min(Fᵢⱼ))/2.

Step 334, if the F₀ concluded in step 332 is the stop point, a determination whether the seeking procedure towards the first seeking direction have been done is made.

Step 336, if it is concluded in step 334 that the seeking procedure towards the first seeking direction has not been done, i is reset to a value of zero, and then the procedure jumps to step 306 where i is increased by 1.

Step 316, if it is concluded in step 334 that the seeking procedure towards the first seeking direction has been done, the optimal input Fₚ is determined. In this instance, the F₀ is identified as the optimal input Fₚ.

In a second exemplary embodiment, a seeking procedure of a method can identifying an optimal input Fₚ corresponding to a maximum output for the processing unit 22. The difference between the first exemplary embodiment and the second exemplary embodiment is described as follows.

When seeking the optimal input Fₚ corresponding to the maximum output O(Fᵢ), a conclusion whether the O(F₀−ΔF) is greater than O(F₀+ΔF) is made. If the first output O(F₀−ΔF) is concluded to be greater than the second output O(F₀+ΔF), the procedure proceeds to step 324 where the seeking procedure is performed towards the second seeking direction. If the determination shows that the first output O(F₀−ΔF) is less than the second output O(F₀+ΔF), the procedure proceeds to step 306 where the seeking procedure is performed towards the first seeking direction.

When determining whether Fᵢ is a stop point, O(Fᵢ), O(Fᵢ₊₁), O(Fᵢ₊₂), and O(Fᵢ₊₃) are compared with each other in step 310 or step 328. If the Fᵢ satisfies relationship of O(Fᵢ)>O(Fᵢ₊₁)>O(Fᵢ₊₂)>O(Fᵢ₊₃) in step 310 or step 328, the Fᵢ is one stop point.

In the first and the second embodiments, four inputs are fed to the processing unit 22 and four corresponding outputs are recorded. In another embodiment, the number of inputs can be another natural number.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

1. A method for optimizing a parameter of a processing unit of an information storage apparatus, the method comprising steps of:
providing an initial input Fᵢ₌₀ to be a value of the parameter, and detecting a corresponding initial output O(Fᵢ₌₀) of the processing unit;
determining step value ΔF;
providing a first input F₀−ΔF and a second input F₀+ΔF to be values of the parameter, and detecting a first output O(F₀−ΔF) and a second output O(F₀+ΔF) of the processing unit;
determining whether the first output O(F₀−ΔF) is greater than the second output O(F₀+ΔF);
determining a first seeking direction based on the determination;
providing other inputs Fᵢ, Fᵢ₊₁, Fᵢ₊₂, . . . Fᵢ₊ₙ₋₁ to be values of the parameters, and then detecting corresponding other outputs O(Fᵢ), O(Fᵢ₊₁), O(Fᵢ₊₂), . . . O(Fᵢ₊ₙ₋₁); wherein n is a natural number;
determining a stop point Fᵢ by comparing the outputs O(Fᵢ), O(Fᵢ₊₁), O(Fᵢ₊₂), . . . O(Fᵢ₊ₙ₋);
stopping seeking along the first seeking direction at the stop point;
identifying an extremum output based on the detected outputs; and
identifying an input corresponding to the extremum output to be the optimized value of the parameter.

2. The method as claimed in claim 1, further comprising steps of:
making a determination whether seeking procedure towards a second seeking direction being opposite to the first seeking direction from the initial input F₀ have been done if F₀ is a stop point; and
resetting i to a value of zero, and seeking along the second seeking direction if the seeking procedure towards the second seeking direction have not been done.

3. The method as claimed in claim 2, further comprising a step of determining Fₚ to be F₀ if the seeking procedure towards the second seeking direction have been done.

4. The method as claimed in claim 3, further comprising a step of resetting the step value ΔF if the first output O(F₀−ΔF) is equal to the second output O(F₀+ΔF).

5. The method as claimed in claim 1, wherein the method is used for identifying an optimal input Fₚ corresponding to a minimum output, and the first seeking direction is towards an input corresponding to a less output of the conclusion from the initial input F₀.

6. The method as claimed in claim 5, wherein Fᵢ is a stop point if Fᵢ satisfies relationship of O(Fᵢ)<O(Fᵢ₊₁)<O(Fᵢ₊₂)< . . . <O(Fᵢ₊ₙ₋).

7. The method as claimed in claim 1, wherein the method is used for identifying an optimal input Fₚ corresponding to a maximum output, and the first seeking direction is towards an input corresponding to a greater output of the conclusion from the initial input F₀.

8. The method as claimed in claim 7, wherein Fᵢ is a stop point if Fᵢ satisfies relationship of O(Fᵢ)>O(Fᵢ₊₁)>O(Fᵢ₊₂)> . . . >O(Fᵢ₊ₙ₋₁).

9. The method as claimed in claim 5, wherein n is equal to 4.

10. The method as claimed in claim 1, further comprising a step of increasing i by 1 based on the conclusion.

11. The method as claimed in claim 1, wherein Fₚ is equal to an average of a maximum value and a minimum value of the certain inputs.

12. The method as claimed in claim 1, wherein i is integer.

13. An information storage apparatus comprising:
an processing unit for receiving parameters;
a parameter-adjusting unit comprising a program for identifying optimal values of the parameters of the processing unit;
wherein the program comprising:
codes for providing an initial input Fᵢ₌₀ to be a value of the parameter, and detecting a corresponding initial output O(Fᵢ₌₀) of the processing unit;
codes for determining step value ΔF;
codes for providing a first input F₀−ΔF and a second input F₀+ΔF to be values of the parameter, and detecting a first output O(F₀−ΔF) and a second output O(F₀+ΔF) of the processing unit;
codes for determining whether the first output O(F₀−ΔF) is greater than the second output O(F₀+ΔF);
codes for determining a first seeking direction based on the determination;
codes for providing other inputs Fᵢ, Fᵢ₊₁, Fᵢ₊₂, . . . Fᵢ₊ₙ₋₁ to be values of the parameters, and then detecting corresponding other outputs O(Fᵢ), O(Fᵢ₊₁), O(Fᵢ₊₂), . . . O(Fᵢ₊ₙ₋₁);
codes for determining a stop point Fᵢ by comparing the outputs O(Fᵢ), O(Fᵢ₊₁), O(Fᵢ₊₂), . . . O(Fᵢ₊ₙ₋₁);
codes for stopping seeking along the first seeking direction at the stop point;
codes for identifying an extremum output based on the detected outputs; and
codes for identifying an input corresponding to the extremum output to be the optimized value of the parameter.

14. The information storage apparatus as claimed in claim 13, wherein the program comprising:
codes for making a determination whether seeking procedure towards a second seeking direction being opposite to the first seeking direction from the initial input F₀ have been done if F₀ is a stop point; and
codes for resetting i to a value of zero, and seeking along the second seeking direction if the seeking procedure towards the second seeking direction have not been done.

15. The information storage apparatus as claimed in claim 14, wherein the program comprising codes for determining Fₚ to be F₀ if the seeking procedure towards the second seeking direction have been done.

16. The information storage apparatus as claimed in claim 15, wherein the program comprising codes for resetting the step value ΔF if the first output O(F₀−ΔF) is equal to the second output O(F₀+ΔF).
